(19) United States
(12) Patent Application Publication
(10) Pub. No.: US 2014/0344135 A1
(43) Pub. Date: Nov. 20, 2014

(54) METHODS AND SYSTEMS FOR PURCHASING SHARES OF AN INVESTMENT COMPANY

(71) Applicant: Merrill Ray Steiner, Newtown Square, PA (US)

(72) Inventor: Merrill Ray Steiner, Newtown Square, PA (US)

(21) Appl. No.: 14/280,816

(22) Filed: May 19, 2014

Related U.S. Application Data
(60) Provisional application No. 61/824,561, filed on May 17, 2013.

(51) Int. Cl. G06Q 40/04

(52) U.S. Cl. CPC G06Q 40/04
USPC 705/37

(57) ABSTRACT

A method of purchasing shares of an investment company is provided. The method includes the step of (a) purchasing shares of an investment company to become a shareholder in the investment company, the investment company being selected from the group consisting of (i) a registered open end investment company, and (ii) an interval fund. The method also includes the step of financing, through a loan in the name of at least one of the shareholder and the investment company, a commission on the shares such that proceeds from the loan may be paid to at least one party due to receive the commission under a purchase agreement of the shares.

### RELATED APPLICATION

This application claims the benefit of priority to U.S. Provisional Patent Application Ser. No. 61/824,561, filed on May 17, 2013, the contents of which are incorporated in this application by reference.

### TECHNICAL FIELD

The present invention relates generally to methods and systems for purchasing shares of an investment company, and more particularly, to such methods and systems in relation to the purchase of shares of investment companies such as registered open end investment companies and interval funds (collectively “mutual funds”).

### BACKGROUND OF THE INVENTION

In order to pay underwriters, distributors, brokers or dealers (“sales agents”) compensation for their activities in selling mutual fund shares, mutual funds typically have agreements with a principal underwriter which has agreements with multiple sales agents permitting the sales agents to receive one or more of three types of sales charges (i.e., commissions) imposed for sales of the mutual fund shares, as follows: (1) a front-end sales charge (“FESC”), which is paid at the time the mutual fund shares are purchased (and consequently, reduces the return on investment (“ROI”) achieved by these shares of the mutual fund over time beginning from the time of the purchase); (2) an asset-based sales charge (“12b-1 Fee”), which is paid pursuant to a plan complying with Rule 12b-1 (“12b-1”) adopted under the Investment Company Act of 1940, as amended (the “1940 Act”), over time at an annual percentage rate applied to the assets held in a mutual fund (and consequently, reduces the ROI achieved by the shares of the mutual fund over time beginning from the time of the purchase); (3) a contingent deferred sales charge (“CDSC”), a sales charge which is deferred to the time that the shares of the mutual fund purchased are sold back to the mutual fund by the shareholder (that is, “redeemed” or “repurchased” by the mutual fund) and varies as a contingency upon how long the shares are held before they are redeemed or repurchased and becomes no charge at all if the shares are held long enough, typically 4-6 years (and consequently, requires the mutual fund to find other ways to compensate sales agents); or (4) a combination of these three types of sales charges.

FIG. 1 illustrates conventional system 100 for purchasing shares of an investment company. System 100 is a typical 12b-1 arrangement for Class B shares investments. Customer 102 (who may also be referred to as a shareholder, as the customer will acquire shares) wants to purchase shares of investment company 110. Investment company 110 receives direction from board/management 112 (e.g., where the board is the Board of Directors, and the management is the management team of investment company 110). Investment company 110 receives additional guidance from investment adviser(s) 114 (e.g., where adviser 114 is registered with the U.S. Securities and Exchange Commission (the “SEC”)). Investment company 110 owns investments 114.

Shareholder 102 may directly order shares 104b from investment company 110, as shown in FIG. 1 (see the dotted line between shares 104b and investment company 110). However, it is more common that shareholder 102 orders shares 104a from selling broker 106, where selling broker 106 is associated with principal underwriter 108, and where principal underwriter 108 is associated with investment company 110.

In an arrangement where shares 104a/104b are purchased under a 12b-1 or similar plan, the commission due to be paid to the principal underwriter (e.g., where the commission is funded from a lender) is made in a series of periodic payments (e.g., one payment per year, such as a 1% payment split into 5 payments over a 5 year period). This type of commission payment system involves certain complexities. First, it is possible that some of the periodic payments may not be made (e.g., the board 112 may decide to stop making the payments as permitted under 12b-1, the SEC may change 12b-1 and the rules related to 12b-1 programs, etc.). Second, principal underwriter 108 receives the payments over a period of years; however, principal underwriter 108 may have to make payments (e.g., commissions 124 shown in FIG. 1) associated with the purchase of the shares 104a immediately after the purchase of shares 104a. To provide for such payments, principal underwriter 108 may take out a loan 122 through a financing agreement 120 with lender 118. Because of the possibility that some of the periodic payments may not be made, it is possible that principal underwriter 108 may not even recoup the funds used to pay for commissions 124 or other associated costs. Thus, it would be desirable to provide improved methods and/or systems for purchasing shares of an investment company.

### BRIEF SUMMARY OF THE INVENTION

According to an exemplary embodiment of the present invention, a method of purchasing shares of an investment company is provided. The method includes the step of (a) purchasing shares of an investment company to become a shareholder in the investment company, the investment company being selected from the group consisting of (i) a registered open end investment company, and (ii) an interval fund. The method also includes the step of financing, through a loan in the name of at least one of the shareholder and the investment company, a commission on the shares such that proceeds from the loan may be paid to at least one party due to receive the commission under a purchase agreement of the shares. For example, the at least one party due to receive the commission may be a broker-dealer (e.g., a principal underwriter, a selling broker associated with the principal underwriter, etc.).

According to another exemplary embodiment of the present invention, a system for purchasing shares of an investment company is provided. The system includes: (a) an investment company, the investment company being selected from the group consisting of (i) a registered open end investment company, and (ii) an interval fund; (b) shares of the investment company available for purchase by a shareholder; and (c) a financing channel configured to provide a loan in the name of at least one of the shareholder and the investment company, the loan being provided to cover a commission on the shares such that proceeds from the loan may be paid to at least one party due to receive the commission under a purchase agreement of the shares. For example, the at least one party due to receive the commission may be a broker-dealer (e.g., a principal underwriter, a selling broker associated with the principal underwriter, etc.).

It is to be understood that both the foregoing general description and the following detailed description are exemplary, but are not restrictive, of the invention.

### BRIEF DESCRIPTION OF THE DRAWINGS

The invention is best understood from the following detailed description when read in connection with the accompanying drawings. It is emphasized that, according to common practice, the various features of the drawings are not to scale. On the contrary, the dimensions of the various features are arbitrarily expanded or reduced for clarity. Included in the drawings are the following figures:

FIG. 1 is a block diagram of a conventional system for purchasing shares of an investment company;

FIG. 2 is a block diagram of a system for purchasing shares of an investment company in accordance with an exemplary embodiment of the present invention;

FIG. 3 is a block diagram of another system for purchasing shares of an investment company in accordance with an exemplary embodiment of the present invention;

FIG. 4 is a block diagram of a computerized ordering system for purchasing shares of an investment company in accordance with an exemplary embodiment of the present invention;

FIG. 5 is a block diagram of a computerized financing system for purchasing shares of an investment company in accordance with an exemplary embodiment of the present invention;

FIG. 6 is a block diagram of a computerized insurance ordering system related to purchasing shares of an investment company in accordance with an exemplary embodiment of the present invention; and

FIG. 7 is a flow diagram illustrating a method of purchasing shares of an investment company in accordance with an exemplary embodiment of the present invention.

### DETAILED DESCRIPTION OF THE INVENTION

The present application relates to various methods and systems for purchasing shares of an investment company, wherein the purchase involves a new method and system to pay the sales charge (e.g., a commission on the purchase of the shares) that can replace or substitute for other methods and systems to pay the sales charges or fees that are currently charged to purchasing shareholders (directly or through brokers) for their purchase of various types of securities. Such securities include, but are not limited to, redeemable shares of any class issued by registered open-end investment companies and shares of any class issued by certain types of registered closed-end investment companies (“interval funds”), each of the foregoing companies being a “mutual fund”. Mutual funds are registered under the Investment Company Act of 1940, as amended (the “1940 Act”), and regulated under the rules and regulations adopted by the U.S. Securities and Exchange Commission (“SEC”) thereunder. The inventive methods and systems provide a mechanism for a lender (e.g., a bank, lender, etc.) to advance on behalf of a shareholder/investor who purchases securities (a “shareholder” or “investor”) funds for payment of sales commissions on the purchase of the securities, where the shareholder/investor directs the payment of the advanced funds to a party (e.g., a broker-dealer) owed the commission in connection with the shareholder/investor purchase of the securities. Exemplary securities include: (1) redeemable shares of any class issued by registered open-end investment companies (“open-end funds”); (2) shares of any class issued by interval funds (collectively, shares issued by open-end funds and interval funds are referred to herein as “mutual fund shares”); (3) units or shares of interests in a private investment company (not registered under the 1940 Act, referred to as a “private fund”); (4) shares issued by public reporting companies listed on an exchange or quoted on a dealer's electronic trading exchange or platform (collectively, the foregoing shares or units, other than mutual fund shares, are referred to herein individually as an “other share,” or collectively, as “other shares”).

Methods and systems according to various exemplary embodiments of the present invention provide investors with a arrangement for financing, with an option of insurance coverage, the sales commissions on sales of shares of investment companies with no reduction in the amount the investors invest in the shares, such that the investor's return on investment can be a percentage of, and take advantage of, the full amount invested over the entire period in which the shares remain invested and owned by the investor.

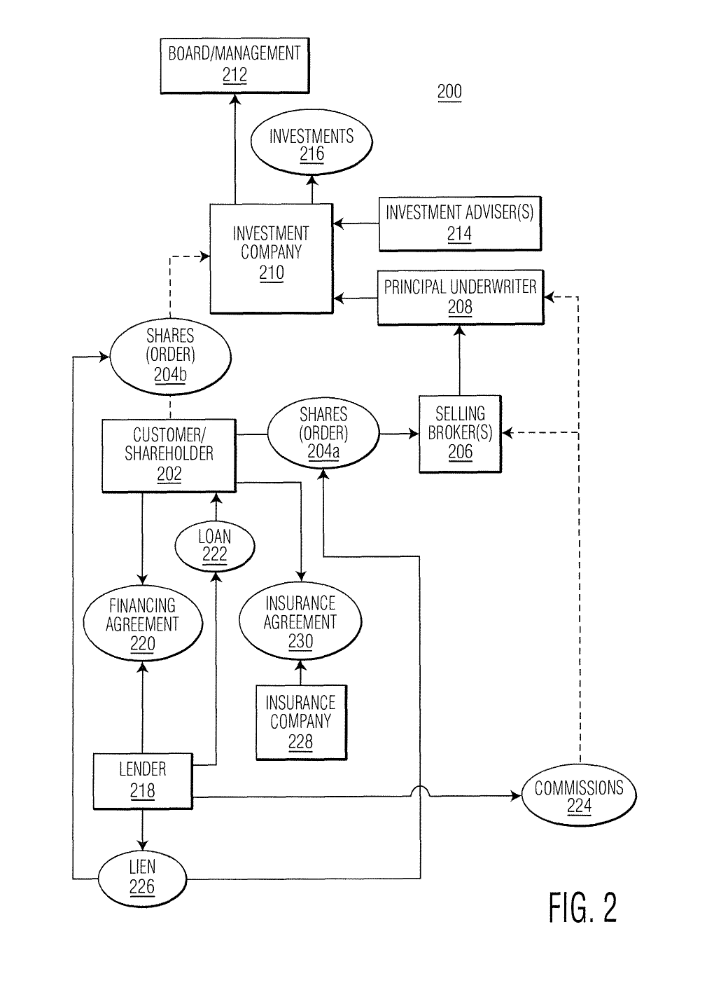

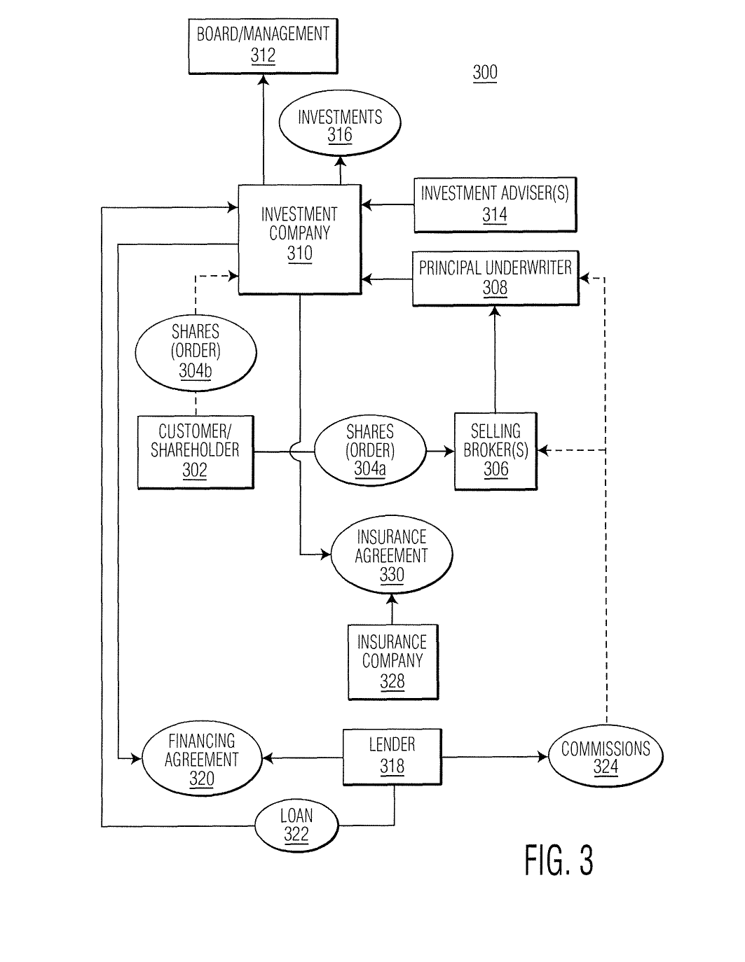

In accordance with certain exemplary embodiments of the present invention, financing (e.g., financing to cover the commissions to be paid associated with the purchase of shares of an investment company) is obtained by shareholder (as shown in FIG. 2) or the investment company (as shown in FIG. 3). Through such financing arrangements (depending upon the exact structure of the financing arrangement), the connection between the repayment of a loan, and the 12b-1 fees revenue stream, may be removed.

Referring specifically to FIG. 2, a system 200 for purchasing shares of an investment company is illustrated. Shareholder 202 wants to purchase shares of investment company 210 (where investment company 210 receives direction from board/management 212, and where investment company 210 receives additional guidance from investment adviser(s) 214). Investment company 210 owns investments 214.

Shareholder 202 may directly order shares 204b from investment company 210, as shown in FIG. 2 (see the dotted line between shares 204b and investment company 210). However, it is more common that shareholder 202 orders shares 204a from selling broker 206, where selling broker 206 is associated with principal underwriter 208, and where principal underwriter 208 is associated with investment company 210.

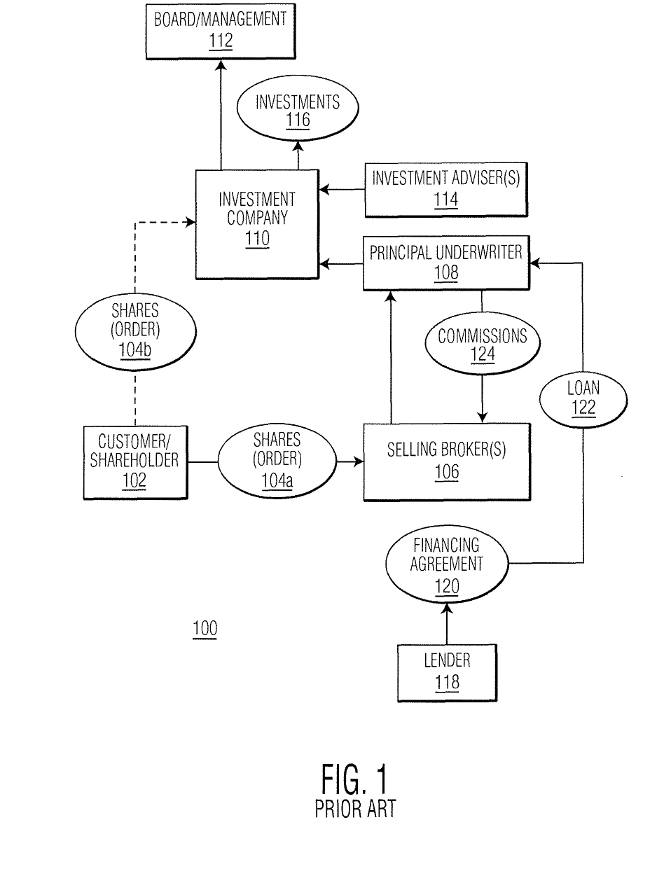

Regardless of how the shares (i.e., shares 204a/204b) are acquired, shareholder 202 engages in loan 222 with lender 218 through execution of a financing agreement 220. Financing agreement 220 is put in place to borrow funds to cover commissions associated with the acquisition of shares 204a/204b, such that the commissions 224 may be provided in full to the party owed the commission under the shares order (e.g., either selling broker 206 or principal underwriter 208, as shown in FIG. 2). Thus, the transaction of FIG. 2 is more like shares transactions currently typically used for Class A shares of mutual funds in that the commissions due on the shares acquisition are paid essentially by the shareholder in full at the time of acquisition without any financing arrangements. For these Class A shares purchases, the commissions are not paid back over a period of years (as in FIG. 1), and as such, the complexities of the FIG. 1 scheme are substantially reduced for both Class A shares and shares acquired through financing agreement 220 in the arrangement of FIG. 2.

Shareholder 202 pays back the loan 222 under the provisions of financing agreement 220 (e.g., over a period of years, using the appreciation in value of shares 204a/204b or using other funds, etc.), and lender 218 holds lien 226 on shares 204a/204b until load 222 is satisfied. System 200 may require that shareholder 202 acquire insurance such that the parties (e.g., such as lender 218) are confident that loan 222 will be repaid. As shown in FIG. 2, shareholder 202 enters into an insurance agreement 230 with insurance company 228. The terms of insurance agreement 230 (and the parties to the insurance agreement) may vary within the scope of the present invention. For example, insurance agreement 230 may provide for insurance company 228 to pay at least a portion of the funds due under loan 222 if shares 204a/204b do not appreciate in value to a certain level and/or if shareholder does not repay at least a portion of the funds due under loan 222 from other sources. Various exemplary arrangements with insurance companies are described throughout the present application.

In certain arrangements, it may be desirable to have the investment company enter into a financing agreement (and/or an insurance agreement) related to the payment of commissions on the shares purchased by the shareholder. Referring specifically to FIG. 3, another system 300 for paying the commissions on purchases of shares of an investment company is illustrated. Shareholder 302 wants to purchase shares of investment company 310 (where investment company 310 receives direction from board/management 312, and where investment company 310 receives additional guidance from investment adviser(s) 314). Investment company 310 owns investments 314.

Shareholder 302 may directly order shares 304b from investment company 310, as shown in FIG. 3 (see the dotted line between shares 304b and investment company 310). However, it is more common that shareholder 302 orders shares 304a from selling broker 306, where selling broker 306 is associated with principal underwriter 308, and where principal underwriter 308 is associated with investment company 310.

Regardless of how the shares (i.e., shares 304a/304b) are acquired, investment company 310 engages in financing agreement 320 with lender 318 (e.g., where financing agreement 320 may involve loan 322 for commissions for various transactions possibly including other shareholders of investment company 310, and not just the transaction related to the acquisition of shares 304a/340b shown in FIG. 3). In any event, financing agreement 320 is put in place to borrow funds to cover at least the commissions associated with the acquisition of shares 304a/304b, such that the commissions 324 may be provided in full to the party owed the commission under the shares order (e.g., either selling broker 306 or principal underwriter 308, as shown in FIG. 2). Thus, the transaction of FIG. 3 is more like shares transactions currently typically used for Class A shares of mutual funds in that the commissions due on the shares acquisition are paid by the shareholder in full essentially at the time of acquisition without any financing arrangements. For these Class A shares purchases, the commissions are not paid back over a period of years (as in FIG. 1), and as such, the complexities of the FIG. 1 scheme are substantially reduced for both Class A shares and shares acquired through financing agreement 320 in the arrangement of FIG. 3.

The loan associated with financing agreement 320 is paid back (i.e., loan 322), for example, over a period of years. The funds used to repay the loan may come from, at least in part, the appreciation in value of shares 304a/304b or using other funds, etc. Lender 318 may hold a lien (or other collateral) on shares 304a/304b until loan 322 is satisfied with respect to the shares 304a/304b.

System 300 may require that investment company 310 acquire insurance such that the parties (e.g., such as lender 318) are confident that the loan associated with financing agreement 320 will be repaid. As shown in FIG. 3, investment company 310 enters into an insurance agreement 330 with insurance company 328. The terms of insurance agreement 330 (and the parties to the insurance agreement) may vary within the scope of the present invention. For example, insurance agreement 330 may provide for insurance company 328 to pay at least a portion of the funds due under loan 322 if shares 304a/304b due not appreciate in value to a certain level and/or if investment company 310 does not repay at least a portion of the funds due under loan 322 associated with financing agreement 320 from other sources. Various exemplary arrangements with insurance companies are described throughout the present application.

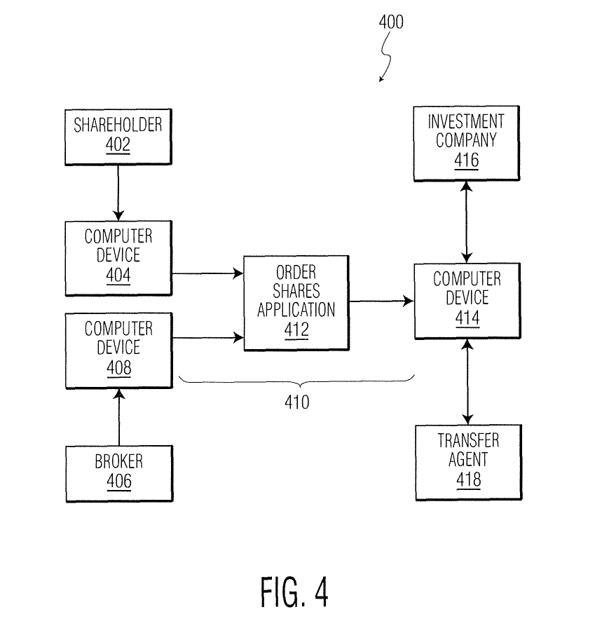

The various transactions associated with systems 200/300 may be accomplished using computer devices (e.g., personal computer devices, server computer devices, tablet computer devices, smartphone computer devices, amongst others) interconnected using various internet paths/channels (including wired and wireless connections). FIGS. 4-6 illustrate exemplary interconnections (and associated software applications) for performing certain of the present invention such as tasks illustrated in FIGS. 2-3. It will be appreciated that certain of the elements of systems 400/500/600 of FIGS. 4-6 may be the same. For example, computer device 404 accessed by shareholder 402 may be the same as computer devices 504/604 (and in fact, shareholder 502/602 may be the same shareholder 402 and investment company 510/610 may be the same investment company 410). Further, ones of the various software applications (e.g., applications 412, 512, 612) may be combined or “wrapped” into a single process for completing the purchase of shares of an investment company.

Referring specifically to FIG. 4, system 400 illustrates shareholder 402 ordering shares (using computer device 404) through software application 412 for ordering shares (e.g., such as shares 204b/304b from FIGS. 2-3) of an investment company. Alternatively, broker 406 may order the shares (e.g., such as shares 204a/304a from FIGS. 2-3) (using computer device 408) through software application 412. As will be appreciated by those skilled in the art, application 412 may be an online software application (which is accessed using internet communication path 410) accessible by shareholder 402 and/or broker 406 (e.g., using an account which may include log in credentials or the like for identifying shareholder 402 and/or broker 406). An order entered by either of shareholder 402/broker 406 (using application 412) is received by investment company 416 (or a designated transfer agent 418 of investment company 416) using computer device 414.

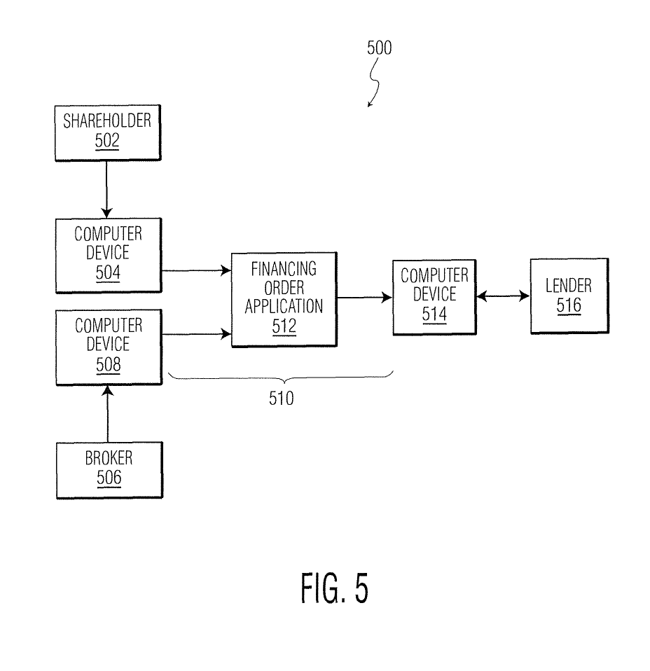

Referring specifically to FIG. 5, system 500 illustrates shareholder 502 entering into a financing agreement (e.g., such as agreement 220 in FIG. 2) using computer device 504 through software application 512 for entering into a financing agreement with lender 516. Alternatively, broker 506 may enter into a financing agreement on behalf of shareholder 502 (using computer device 508) through software application 512. While not shown in FIG. 5, the investment company may also enter into a financing agreement (such as agreement 320 in FIG. 3) using software application 512. As will be appreciated by those skilled in the art, application 512 may be an online software application (which is accessed using internet communication path 4510) accessible by shareholder 502, broker 506, or an investment company entering into the financing agreement (e.g., using an account which may include log in credentials or the like for identifying shareholder 502, broker 506, and/or the investment company). A financing agreement ordered by either of shareholder 502/broker 506 (or by the investment company in a FIG. 3 type of arrangement) (using application 512) is received by lender 516 using computer device 514.

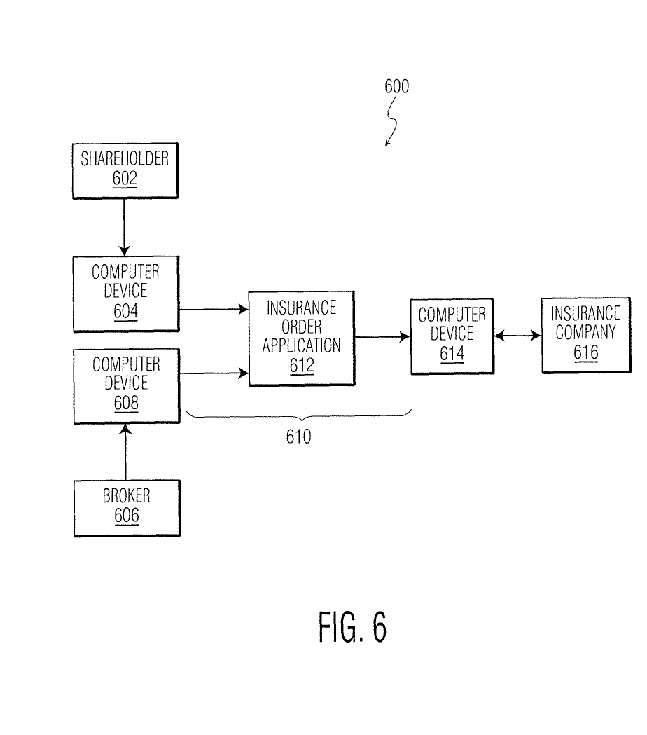

Referring specifically to FIG. 6, system 600 illustrates shareholder 602 entering into an insurance agreement (e.g., such as agreement 230 in FIG. 2) using computer device 604 through software application 612 for entering into an insurance agreement with insurance company 616. Alternatively, broker 606 may enter into an insurance agreement on behalf of shareholder 602 (using computer device 608) through software application 612. While not shown in FIG. 6, the investment company may also enter into an insurance agreement (such as agreement 330 in FIG. 3) using software application 612. As will be appreciated by those skilled in the art, application 612 may be an online software application (which is accessed using internet communication path 610) accessible by shareholder 602, broker 606, or an investment company entering into the financing agreement (e.g., using an account which may include log in credentials or the like for identifying shareholder 602, broker 606, and/or the investment company). An insurance agreement ordered by either of shareholder 602/broker 606 (or by the investment company in a FIG. 3 type of arrangement) (using application 612) is received by insurance company 616 using computer device 614.

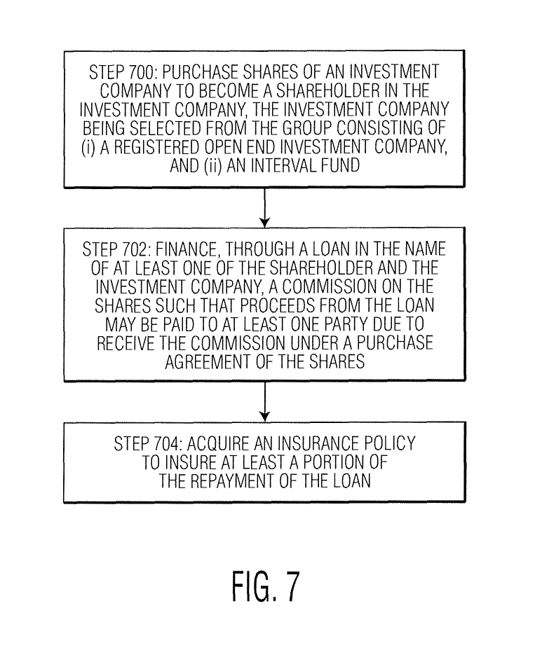

FIG. 7 is a flow diagram illustrating a method of purchasing shares of an investment company in accordance with an exemplary embodiment of the present invention. As will be appreciated by those skilled in the art, the order of the steps in FIG. 7 may be varied from that shown. Further, additional (or different) steps may be added within the scope of the present invention, as described herein.

Referring specifically to FIG. 7 (which is an example of a method that may be performed using any of the systems shown in FIGS. 2-6), at step 700, shares of an investment company are purchased such that an investor/customer becomes a shareholder in the investment company (where the investor/customer may already be a shareholder of the investment company). The investment company is selected from the group consisting of (i) a registered open end investment company, and (ii) an interval fund. At step 702, a loan is financed in the name of at least one of the shareholder and the investment company to fund a commission on the shares such that proceeds from the loan may be paid to at least one party (e.g., the selling broker, the broker-dealer, the principal underwriter, etc.) due to receive the commission under a purchase agreement of the shares. At step 704, an insurance policy is acquired (e.g., by the shareholder, by the investment company, etc.) to insure at least a portion of the repayment of the loan. The insurance company may be procured to insure the value of the entire commission, or a value of a partial payment of the commission. Various exemplary details related to the insurance policy are recited herein.

The generic description of the invention set forth above is described in greater detail below in connection with various exemplary, and non-limiting, embodiments.

In accordance with various exemplary embodiments of the present invention, systems and methods are provided to pay a commission (e.g., the FESC) upon purchase of mutual fund shares or other shares. The inventive methods and systems present new ways to pay the FESC upon purchase of mutual fund shares or other shares using financing by a lender (e.g., a bank or other financial institution) and insurance written by an insurance company. Using such systems/methods, the purchasing shareholder may enter into a tri-party agreement with the lender and insurance company which provides that: (1) the lender will pay the FESC for the mutual fund shares that impose a FESC, or for other shares subject to a sales commission, in a financing that may have a term of one or more years (most likely not exceeding eight to ten years); (2) the purchaser of the shares will pay principal and interest to the bank, and insurance premiums to the insurance company during the term of the financing on an installment basis for sub-periods of the full term of the financing, typically one-year or six-months periods that are the installment repayment periods of the financing; (3) the parties will place the mutual fund shares or other shares in a collateral account with the lender subject to a secured interest in favor of the lender for the amounts of principal, interest and insurance premiums with respect to the financing that become due and payable from time to time, which secured interest will be released when the full amount of principal and interest has been prepaid in full or repaid at the end of the full term of the financing; (4) under the agreement, the insurance company will write a policy with coverage for the amount of any principal and interest payment due and payable at the end of an installment repayment period to the extent that such amount of principal and interest exceeds the then currently available gain on the mutual fund shares or other shares purchased; and (5) the purchasing shareholder will agree to pay the insurance premium for the initial installment repayment period of the financing at the beginning of the period as an addition to the FESC advanced by the bank and, for any subsequent installment repayment period, to pay the insurance premium at the beginning of the period from (a) the amount of any available gain on the purchased mutual fund shares or other shares that exceeds the amount of any principal and interest payment due and payable at the end of an installment repayment period, or (b) if there is no available gain or not enough available gain, any shortage in the amount available to pay the principal, interest or premium, in that order, from the proceeds of the insurance coverage.

There are a number of important distinctions between (1) sales charges (i.e., commissions) permitted in connection with conventional sales of mutual fund shares and (2) sales charges (i.e., commissions) under the various inventive systems and methods disclosed herein. Referring specifically to conventional Rule 12b-1 sales charges, they are typically imposed as a percentage of the average daily net assets of the mutual fund. That is, 12b-1 permits, under the right circumstances and with proper Board or shareholders' approvals, a mutual fund to pay sales charges, within limits, for the distribution (sale) of its mutual fund shares over time through the imposition of charges (“12b-1 fees”) as a percentage at an annual rate of the average daily net asset value (“NAV”) of the mutual fund. Because the inventive methods and systems provide that a full commission (e.g., FESC) may be paid at the time of purchase of mutual fund shares (with no other payment being due or payable to the sales agent as compensation for selling or distributing mutual fund shares), the inventive methods and system allow for a payment plan that operates outside of the mutual fund. The Mutual Fund does not pay any amount for the distribution (sale) of its shares over time through the imposition of 12b-1 fees as a percentage at an annual rate of the average daily NAV. Consequently, 12b-1 does not apply to or restrict such inventive methods/systems, or the class of shares of the mutual fund for which such inventive methods/systems is designed.

Deferred sales charges (or loads) are governed by Rule 6c-10 adopted under the 1940 Act. Deferred sales charges for the distribution (sale) of mutual fund shares are usually imposed on the shares in the form of contingent deferred sales charges (“CDSCs”) where the amount of the charge is contingent on the period of time that has expired since the shares were purchased, with the amount of the charge decreasing each year according to a disclosed schedule until no amount is charged in later years. CDSCs are usually imposed along with 12b-1 fees in a manner that replaces the reduction in the amount of the CDSC payable by the shareholder to the sales agent with each passing year with the amount of the 12b-1 fees payable to the sales agent for such year. Financing arrangements under inventive methods/systems according to the present invention do not involve a deferred sales charge, and Rule 6c-10 does not apply, because the full commission (e.g., FESC) is paid (e.g., by a lender on behalf of the shareholder) to the sales agent at the time the shares are purchased; that is, later payments (e.g., by the shareholder) are simply repayments of amounts loaned by the lender to pay the FESC initially.

Current Rule 12b-1 has been heavily criticized, and is under review for revision by the SEC staff. Mr. Andrew Donahue, the SEC's former Director of the Division of Investment Management was particularly critical of Rule 12b-1 and was among the strongest supporters of the SEC proposal of a new rule, Rule 12b-2, which would rescind and replace Rule 12b-1. Judging from the time it is taking the SEC to amend Rule 12b-1, as the SEC has indicated for a number of years is necessary, the SEC staff seems to be working through multiple issues for proposed revisions acceptable to both the SEC and the Mutual Fund industry (“Industry”). 12b-1 plays such a crucial part in the distribution and payments for distribution of shares of mutual funds that both the SEC and the Industry are seeking to resolve the vexing problems with 12b-1 in a manner that preserves the recognized benefits of 12b-1, while protecting returns for investors, and providing a reasonable degree of enterprise profitability for sales agents and the Industry.

Commissions paid to broker-dealers under 12b-1 have certain recognized benefits. The purchase of mutual funds by retail investors is vital to the United States national interest of fostering the formation of capital to support the development and maintenance of companies to grow the national economy and jobs. Anything that encourages and fosters savings and investments is good for the nation and its citizens. When retail investors have the protection of law, understand how to invest in ways that attain their investment goals, and pay no more than a fair price for the investing information and management of their investments, the investors are encouraged, and much more likely, to invest in mutual funds. The following are key factors for investments in mutual funds: (1) investors should be educated about the advantages and disadvantages of investing in mutual funds and other investments—with sales agents providing this education at least in part, whether under 12b-1 or other forms of sales charges, such as CDSCs or FESCs, including commissions paid under the inventive systems/methods disclosed herein; and (2) the greater the net assets of a mutual fund, the greater the economies of scale that are possible to defray the expenses that the fund pays—and some have argued that these economies of scale have unfortunately been offset by a lack of reasonableness and proportionality in the costs and expenses charged on the part of the Industry and sales agents through conventional arrangements.

The inventive methods and systems recited herein provide a source of revenue for lenders (e.g., where such revenue is derived from financing the sales commissions paid by investors who purchase mutual fund shares or other shares of investment companies) and for insurance companies (e.g., where such revenue is derived from writing the related insurance coverage, for example, on this new risk class of losses derived from the decrease in value, or the lack of increase in value, of the shares purchased with the sales commissions, a risk in effect during the year or longer period over which the insurance coverage is in effect). Below is a summary of the benefits to lenders, insurance companies, broker-dealers, investors and mutual funds.

Exemplary benefits for lenders (e.g., banks): (1) the lender earns interest on the amount of sales commissions advanced over the life of the loan to the investor to cover the sales commissions; (2) the lender may be covered against loss by a security interest in the securities bought and by the insurance covering any losses in the value of securities; (3) a lender affiliated with a broker-dealer can potentially lend the securities bought by the investor in which the lender has a security interest during the period of an advance of funds to the investor, which reduces the interest that must be charged or increases the profit to the bank; (3) a lender affiliated with a broker-dealer can potentially lend the investor additional amounts based on the full amount of the securities bought by the investor; and (5) the lender avoids all the costs, delays and difficulties in negotiating complex financing agreements with funds and distributors and the risks of contract administration, termination of the 12b-1 fees by the mutual fund board and regulatory change to Rule 12b-1.

Exemplary benefits for insurance companies: (1) the insurance company has a new insurance product; and (2) the new insurance product has a low risk—for example, covering losses for the amount due for principal and interest in a given year, if the return on the securities bought is not enough to cover the annual principal and interest due for that year on the remaining amount advanced for the sales commissions or charges.

Exemplary benefits for broker-dealers: (1) a broker-dealer can execute sales of securities without having the purchasing investors face large FESCs or vague sales charges that have the potential to balloon over time and reduce investor ROI; (2) since the broker-dealer will no longer have to finance the payments of FESCs in return for 12b-1 fee receivables over time, it will not have to (a) take large reductions in its net capital position to cover sales charge financing over time—a net capital position it must maintain under securities regulations, (b) find a source of financing to cover sales charge financing over time and pay for expensive negotiation, documentation and administration of such financing, or (c) share in the ROI of the purchasing investor by receiving a percentage of that ROI over time.

Exemplary benefits for investors/shareholders: (1) the full amount of the investor's investment begins earning an ROI immediately with no reduction to pay the sales commission—enhancing the ROI the investor will receive over the life of the investment; (2) the amount of sales charges the investor will pay will be fixed, and not subject to increase based on the appreciation in value of the securities (as in the case of 12b-1 fees); (3) the investor will receive up-front disclosure of the full amount of sales commissions or charges the investor will pay, including interest and premium payments; and (4) the investor will be able to pay principal, interest and premium charges from (a) its own resources or (b) the ROI the investor earns on the securities purchased through the inventive methods and systems, if the securities increase in value, or have the payments made by the insurance company if the securities do not increase in value, during a predetermined period.

Exemplary benefits for mutual funds: (1) the mutual fund's NAV and annual ROI will be enhanced because the full amount of investor's investment begins earning a return immediately, because there is no reduction in the amount invested in the fund to pay an FESCs; and because there is no annual reduction to the fund's NAV and annual ROIs to pay 12b-1 fees; (2) the mutual fund will sell more shares as investors will be more satisfied with an increased ROI, up-front disclosure of full amount of sales commissions the investor will pay including interest and premium payments, not having to face large FESCs or ever increasing 12b-1 fees (where such 12b-1 fees have the potential to balloon over time and reduce Investor ROI, and cannot be determined at time of sale, so the amount is not fully disclosed or understood by the Investor); and (3) the mutual fund's board does not have to conduct time-consuming quarterly reviews of 12b-1 fee amounts and annual approvals of 12b-1 plans.

Below is a description of examples of the inventive methods and systems, including various preferred and exemplary embodiments for implementing the methods and systems using computer programs and servers to record, monitor and maintain necessary sales and fee data and information. The following descriptions may refer to the arrangement (including the entities, elements, and connections) shown in FIGS. 2-3.

According to an exemplary embodiment for implementing the inventive methods and systems, the selling broker-dealer (“Broker”) or other sales agent is paid the full amount of the sales charge (i.e., the commission) at the time of sales of the mutual fund shares of the applicable class (the “New Plan Shares”), essentially an FESC, or the full amount of the sales commissions, also essentially an FESC, paid at the time of the sales of other shares (also, “New Plan Shares”). Further, an insurance company (“Insurer”) is paid the first year's premium, at the time of sale of New Plan Shares to the investor, for example, using funds provided by a lender (e.g., a bank or other financing company, aka a “Lender”). This means the full amount provided by the investor that purchases the New Plan Shares is invested in the shares and the investor will realize gains (or losses) on the full amount invested. If the commission (e.g., the FESC or sales commission on the other shares) was deducted from the amount provided by the investor, the amount invested would be less and the investor would not realize gains (or losses) on the amount deducted and not invested in the New Plan Shares.

On a predetermined time period or other interval (e.g., at the anniversary of the sale of the New Plan Shares to the Investor, or the passage of another shorter period of time (e.g., six months)), the investor (aka the customer or shareholder) repays the lender a portion of the amount of the sales charges or commissions advanced to the investor at the time of sale. The amount the investor pays for each time period/interval (e.g., each year) may optionally includes payment of a premium for the insurance coverage of the principal (that may be advanced by the lender) that has not yet been repaid but is due and payable at the end of the applicable time period along with related interest earned for such applicable time period. In a specific exemplary variation, the insurance policy is renewed for each one-year period (or other designated period), subject to being limited to a shorter period ending on the date the investor, in the investor's discretion, has the New Plan Shares redeemed or repurchased, in the case of Mutual Fund shares, or sold, in the case of other shares. In this way the insurer (insurance company) may be liable to cover principal and interest payments for only one-year (or other designated) periods or partial periods prior to (1) the redemption or repurchase of the New Plan Shares, in the case of mutual fund shares or, in the case of other shares that are redeemed or repurchased by the issuer, or (2) the sale of the other shares to other investors, in the case of other shares that are not redeemed or repurchased by the issuer.

The insurer may take into account the risk that the investor may have, or be able to obtain, a greater recovery from the insurer for repayment of principal and interest to the lender based on an inadequate investment return performance of the New Plan Shares at the time of a redemption, repurchase or sale of the New Plan Shares, the timing of which is in the sole discretion of the investor. This risk to the insurer may be mitigated since the investor generally does not have any incentive to sell at a time of poor investment return. The premium necessary to cover each succeeding one-year (or other designated) period may be reduced for each succeeding one-year (or other designated) period, because the amount of remaining principal that had not been repaid and related interest payable thereon would be reduced with each passing year (or other designated period), so that any insufficient gain or a loss on the New Plan Shares for the year (or other designated period) that the insurer would cover would be less and less with each passing year (or other designated period).

In further exemplary embodiments of the inventive methods and systems, the insurer could consider writing insurance with higher premiums to cover repayment of principal and interest for longer than one-year (or other designated) periods, but this consideration would have to take into account the potential for early redemption, repurchase or sale of the New Plan Shares in the sole discretion of the investor, which would (1) truncate the period over which the New Plan Shares might have had higher potential gains (thereby reducing the insurance risk) and (2) increase the potential for losses that could occur at the end of the shorter period of time (thereby increasing the insurance risk.).

The insurer (or lender, under agreement with the insurer) could reduce the insured risks by entering into hedging arrangements through investments in instruments that would offset the risk of loss by the New Plan Shares for which the insurer would have to make up the difference under the inventive methods/systems described herein. Also, in writing the insurance, the insurer could take into account the relative riskiness of the investments made by the mutual funds whose shares are purchased, or, in the case of the other shares, the relative riskiness of the investments made by the private investment funds or the relative riskiness of investing in the public companies whose shares are purchased, in any of the foregoing cases, by the investor under the inventive methods/systems. The insurer could also take into account, for mutual fund shares, the risk that the investor may exchange the investor's purchased New Plan Shares for shares of other mutual funds in the mutual fund complex or family of funds and the relative greater or lesser riskiness of the investments made by those other mutual funds for whose shares the purchased New Plan Shares are exchanged. The exchange of New Plan Shares that are mutual fund shares are further discussed below.

In certain exemplary embodiments of the present invention, the lender extends credit to the investor (shareholder) in the amount of the commission/FESC (or in the case of other shares, the amount of the sales commissions paid on the sales of other shares). In such arrangements, the financing may be supported by a secured interest in the New Plan Shares purchased. The lender may place the New Plan Shares, if certificated, in a collateral account at the bank, or since the shares are most likely not certificated, but in book entry form, may become the nominee holder of record of the New Plan Shares (while the investor remains the beneficial owner of the New Plan Shares). In this way the lender may subject the New Plan Shares to a secured interest in favor of the lender (which reduces the risk to the insurer) for the amounts of principal, interest and insurance premiums that become due and payable from time to time. The amount the investor pays at inception and for each year (or other designated period) thereafter may include payment of a premium for insurance coverage of the principal loaned and interest to be earned for the year (or other designated period), unless the investor makes other arrangements or has the creditworthiness not to be required to have the insurance coverage, which is another potential embodiment for implementing the inventive methods/systems.

In other exemplary embodiments of the present invention, as a promotional feature granted by the lender to encourage the investor to use the credit provided by the lender to pay the commission (e.g., FESC), the investor may be given the option of paying off the amount of this commission (or in the case of other shares, the amount of the sales commissions or charges paid on the sales of other shares) that has been advanced to the investor, without the payment of interest (or, possibly, any insurance premium, if the lender had an arrangement with the insurance company to be self-insured for the applicable initial period), from any source of funds the investor has, including, but not limited to, the redemption of New Plan Shares or using a credit or charge card, so long as the investor pays the full amount of the commission within a designated period such as ninety days, six months or one year that financing companies arrange as incentives for this type of financing (the “Interest-Free Period”).

In other exemplary embodiments of the present invention, all or a portion of the commission (e.g., FESC) (or in the case of other shares, the amount of the sales commissions or charges payable on the sales of other shares) can be waived by the broker or other sales agent (at the option of the broker or other sales agent—in the nature of volume sales or special sales incentives) and not paid by the investor so that the amount financed by the lender for the investor is less than the full amount of the commission (or in the case of other shares, the amount of the sales commissions or charges payable on the sales of other shares).

In other exemplary embodiments of the present invention, if the investor does not pay off the entire amount of the commission (e.g., FESC, or in the case of other shares, the amount of the sales commissions or charges paid on the sales of other shares) that was advanced to the sales agent by the lender within an interest-free period, if any, the amount of the commission financed by the lender and insurance premium advanced for each year (or other designated period), will be paid back to the lender in installments over time, for example, annually on the anniversary of the purchase of the New Plan Shares, with the addition of interest payments for the amount financed over each applicable annual period (or other designated period). The amount the investor pays for each year (or other designated period), includes payment of a premium for the insurance coverage of the principal advanced that has not yet been repaid and interest earned for the year (or other designated period), as more fully described below (unless the investor makes other arrangements for prepayment of the advanced amount or, with respect to the insurance premium, the investor has the creditworthiness not to be required to have the insurance). The amount of the commission is paid back in five installments, for example, as follows for one-year periods (or other such time periods), depending on whether or not there is a gain or enough of a gain on the New Plan Shares during the year. In a specific example, if there is a gain on New Plan Shares at the first-year anniversary of purchase of the New Plan Shares, a portion of the amount financed in the range of 20% or some other agreed upon percentage is paid from, as applicable: (a) the investor's mutual fund account, through redemption of New Plan Shares; (b) in the case of other shares, the investor's private investment fund account (so long as liquidity of shares in such fund are provided for by fund management) through redemption of New Plan Shares; (c) for other shares that are shares of an individual company, by the sale of such shares, if there is a secondary market for such shares and the holding period and transaction limitation rules are met; or (d) other resources of the investor where the investor may make other arrangements to pay the amount from the investor's other resources including, but not limited to, a credit or charge card, to the lender, representing repayment of one-fifth, one-sixth, or some other agreed upon percentage, of the principal amount of the commission (e.g., FESC) or other sales commission or charge (taking for example a five-, six- or other-year repayment plan), with the remaining portion of the payment amount constituting interest earned on the financing for the first year (if not previously paid) and the insurance premium for the second year of coverage. If there is not enough gain on the New Plan Shares during the first year after purchase of the New Plan Shares (and the investor does not, at the option of the investor, make any other provisions to pay the amount due from the investor's other resources) to cover the 20% or other agreed upon percentage payment to the lender, or if there is no gain or a loss on the New Plan Shares, the amount of any gain is paid to the lender as return of principal on the financing (and, if enough, as payment of a portion of the interest) and the insurer pays the lender the remaining amount of the principal payment due at the end of the year, if any, and any remaining amount of interest earned on the financing for the first year. The insurance premium for the second year is advanced by the lender at this time or is paid by the investor directly to the insurer at this time, as agreed upon in the financing agreement. In this exemplary embodiment for implementing the methods/systems, the insurer's risks are limited by the fact that the insurer is obligated to pay at most only the remaining installment(s) of unpaid principal of the commission (e.g., FESC) or sales commissions or charges advanced by the lender and the interest on such remaining installment(s) of unpaid principal of the commission (e.g., FESC) or sales commission or charges advanced, not the full amount of the investor's investment in the New Plan Shares, in the event there is not enough gain or there is a loss on such purchased New Plan Shares in some or all of the annual (or other designated) installment payment periods, as applicable.

For each of the anniversaries subsequent to the first year (or the ending date of other designated periods of time subsequent to the first designated period) after the purchase of the New Plan Shares, the same payment arrangements are followed, contingent on the amount of any gain or a loss on the New Plan Shares in such subsequent year (or other designated period), until the full amount of the principal is repaid to the lender by the investor, or, where there is insufficient gain, no gain or a loss on the New Plan Shares, by the insurer, if any, with the interest and insurance premium for each year (or other designated period), including the final year (or other designated period) in which repayment is made (when no further insurance premium is due).

The interest charged for the amount of commission (e.g., FESC) on the purchase of the New Plan Shares may be either at a fixed rate or a variable rate of interest. A key point for the amount of interest and premiums that may be charged is that interest and premiums should not be deemed sales commissions or charges or part of the sales commissions or charges imposed. Interest and premium payments represent payments for products or services that are over and above the assistance or brokerage provided by the broker in the purchase of the New Plan Shares. Only charges for such brokerage assistance by the broker and brokerage should be treated as sales commissions or charges, and interest and premium payments should not be treated as sales commissions or charges, for purposes of the limits on sales commissions or charges imposed by FINRA's NASD Conduct Rule 2830, NASD Conduct Rules 2440 and IM-2440-1, the rules of any national securities exchange or the rules adopted by the SEC under the 1940 Act, as applicable.

In certain exemplary embodiments of the present invention, the lender and insurer will have the capability, with their service providers, after the New Plan Shares are purchased, to track the NAV (net asset value) of the New Plan Shares as provided by the mutual fund complex or private investment fund and the applicable interest and premium payments that become due and payable. Likewise, the present invention contemplates that the lender and insurer will have the capability, with their service providers, after the New Plan Shares that are other shares are purchased, to track the pricing or fair market value, as applicable, of the New Plan Shares issued by public companies or other issuers than mutual funds or private investment funds, as provided by pricing services, securities exchanges or securities quotation systems, and the applicable interest and premium payments that become due and payable.

The invoices provided to New Plan Share shareholders may disclose information such as the remaining principal, amount of interest and amount of premiums due, and the amount of the principal and interest paid by the insurer, if any, during the given time period. The invoices may also disclose which New Plan Shares are subject to the obligation to make the payments. For mutual fund shares, the invoices may track changes in such New Plan Shares as they are exchanged for New Plan Shares of other mutual funds in the Mutual Fund complex or family (as discussed below). In order to track the exchange of New Plan Shares of one mutual fund for shares of another mutual fund in the fund complex or family, the lender's arrangements (1) for placing the New Plan Shares, if certificated, in a collateral account at the bank, or (2) since the shares are most likely not certificated, in book entry form, for becoming the nominee holder of record of the New Plan Shares (while the investor remains the beneficial owner) will need to make provisions for exchanging the certificates of the New Plan Shares given in exchange, or making new book entries to record the lender as the nominee holder of record (in place of the New Plan Shares given in exchange) for the New Plan Shares received in the exchange. In this way the lender may continue to subject the New Plan Shares to a secured interest in favor of the lender (which reduces the risk to the insurer) for the amounts of principal, interest and insurance premiums that become due and payable from time to time by the investor to the lender.

In certain exemplary embodiments of the present invention, to the extent that any of the New Plan Shares are redeemed, repurchased or sold before the entire principal amount of the financed commission (e.g., FESC) or other sales commission or charge, plus any interest accrued to the date of redemption, repurchase or sale, is paid off, the remaining amount of the commission (e.g., FESC) or other sales commission or charge, plus any interest accrued to the date of redemption, repurchase or sale, may be paid: (1) from the amount of any gain, if there is enough gain on the applicable New Plan Shares to pay the entire remaining amount of principal for the commission (e.g., FESC) or other sales commission plus interest then due at the time of redemption, repurchase or sale, or by the shareholder if the shareholder pays the remaining amount of this principal or interest from the other resources of the shareholder, in either case, with a reimbursement to the shareholder of the portion of the premium that had been paid for insurance coverage for the then current repayment period, as a pro rata return for the unused coverage for the remaining period after the redemption, repurchase or sale until the end of the current payment period; or (2) by the insurer, (a) to the extent there is not enough gain on the New Plan Shares purchased to pay the amount of such principal and interest for the then current repayment period as of the time of redemption, repurchase or sale, or (b) if there is a loss on the New Plan Shares for the current period prior to redemption, repurchase or sale, so that in either case, the insurer will pay all or the insurer's applicable portion of the remaining amount of principal and interest then due and payable by the shareholder as of the date of redemption, repurchase or sale which (i) exceeds the gain, if any, on the New Plan Shares or, (ii) if there is a loss, is the entire remaining amount of principal and interest then due and payable by the shareholder as of such date. This amount that is paid by the insurer is the amount of coverage due from the insurer at that time, and includes, in addition, a reimbursement to the investor of the portion of the premium that had been paid for insurance coverage for the then current repayment period, as a pro rata return for the unused coverage for the remaining period after the redemption, repurchase or sale until the end of the current payment period.

In certain exemplary embodiments of the present invention, for mutual fund shares, each installment payment and the remaining portion of the financed commission described in the immediately preceding paragraph, while similar to a deferred sales load or CDSC, does not come within the definition of a “deferred sales load” (“sales load” is another term for “sales charge”) as “any amount properly chargeable to sales or promotional expenses that is paid by a shareholder after purchase but before or upon redemption” as defined in Rule 6c-10. The amount properly chargeable to sales and promotional expenses is paid by the investor under the inventive methods/systems at the time of purchase of the New Plan Shares as a commission (e.g., FESC), when the shareholder becomes irrevocably obligated to repay to the lender the amount of the commission plus accrued interest, which amounts to a credit financing of the commission. This amount properly chargeable to sales and promotional expenses is paid at the time of purchase and not after purchase or before or upon redemption. The remaining portion of the commission plus any interest due will not be the same as a deferred sales load or CDSC because (1) the amount of the principal to be repaid will be fixed at the time of purchase and the shareholder will become obligated to pay that amount of principal applicable for the period to be financed (and interest and premium payments, as applicable) upon purchase of the New Plan Shares, regardless of when or whether or not the New Plan Shares are redeemed, repurchased or sold, (2) the amount actually paid at time of redemption, repurchase or sale will vary depending on the payment history of the New Plan Shares during the period from inception (date of the purchase) to the date of redemption, repurchase or sale rather than according to a fixed reduction schedule, and (3) the amount paid by the shareholder may be reduced by the amount paid by the insurer depending on the extent of any gain or loss on the New Plan Shares as of the end of each principal and interest repayment period and upon redemption, repurchase or sale.

In certain exemplary embodiments of the present invention, in arrangements when the New Plan Shares are redeemed, repurchased or sold during the repayment period resulting in a partial year calculation, and using, for example only, one year as the measurement period for the principal, interest and insurance premium payments, the amount of principal and interest paid by the shareholder will be imposed and calculated, with respect to such a partial year from the most recent anniversary of purchase of the New Plan Shares when applicable payments of principal, interest and premiums were last made until the date when the New Plan Shares are redeemed, repurchased or sold (before the completion of such one-year period when the years' principal, interest and premiums would otherwise be due and payable) (a “Partial Year”), as follows: (1) if there is a gain on the New Plan Shares during the Partial Year, there is paid from the investor's redemption, repurchase or sales proceeds (and a pro-rata portion of the insurance premium previously paid for the current year that is refunded by the lender for the portion of the current year remaining after the Partial Year) the remaining amount of the unpaid principal balance on the commission (which had been advanced by the lender on the date of purchase of such New Plan Shares) and the interest earned on this financing of such New Plan Shares as of the date such New Plan Shares are redeemed, repurchased or sold, which results in the Partial Year; (2) if, instead of the foregoing, there is not enough gain on the New Plan Shares that are redeemed, repurchased or sold for the Partial Year, or if there is no gain or a loss on the New Plan Shares for such Partial Year, the amount of any gain on the New Plan Shares redeemed, repurchased or sold is paid to the lender as return of principal (and, if enough to cover the entire remaining principal payment, then as payment of as much of the then accrued interest as possible) and the insurer pays the lender the remaining principal that is unpaid from the proceeds of the redemption, repurchase or sale of the New Plan Shares, if any, and any remaining then accrued interest earned for the Partial Year; (3) the insurance may be written to cover repayment of principal and interest in either of two ways, if a Partial Year occurs prior to the last repayment year of the financing, including (a) the insurer may agree to be liable and underwrite the insurance to cover the entire remaining principal due and payable to the lender (and any related then accrued interest) to the extent the proceeds of the redemption, repurchase or sale are not enough to cover such principal and interest, or (b) the insurer may agree to be liable and underwrite the insurance to cover only the remaining principal due and payable to the lender at the end of the then current repayment year (and any related then accrued interest) to the extent the proceeds of the redemption, repurchase or sale are not enough to cover such principal and interest—and in the case of (a), the insurer would be subject to the risk that the investor, by deciding when to have the New Plan Shares redeemed, repurchased or sold, could recover from the insurer the remaining amount of the principal due and payable to the lender for the entire remaining term of the financing, including the remaining amount of the principal due and payable to the lender and any related interest for the then current Partial Year—and in the case of (b) the insurer is liable to make up the difference in any shortage of gain that occurs during any one given year or Partial Year, and is not liable to repay the entire principal amount for which the Investor is liable to the lender after the Investor elects to have the New Plan Shares redeemed, repurchased or sold before the full term of the financing is complete—and in the case of either (a) or (b), as stated above, the insurer will have to take into account the risk that the investor may have, or be able to obtain, a greater recovery from the insurer for repayment of principal and interest to the lender based on an inadequate investment return performance of the New Plan Shares at the time of a redemption, repurchase or sale of the New Plan Shares, the timing of which is in the sole discretion of the investor—where the risk to the insurer may be mitigated since the investor generally or normally does not have any incentive to sell at a time of poor investment return; (4) if, after the foregoing payments are made, in the case of clause (b) above, any remaining principal is due and payable to the lender at the time of redemption, repurchase or sale of the New Plan Shares, for repayment periods following the then current Partial Year, the investor will pay, from the redemption, repurchase or sale proceeds of the New Plan Shares or any other source available to the investor, such remaining principal amount due and payable regardless of the fact that there is not enough gain on the New Plan Shares to cover such remaining principal amount; and (5) if the redemption, repurchase or sale of the New Plan Shares coincides with the anniversary of the purchase of such New Plan Shares and any remaining principal is due and payable to the lender at the time of redemption, repurchase the then current repayment period may be treated as a Partial Year in accordance with the this section of the present application.

An important feature of mutual funds is that they offer their shareholders the ability to exchange their shares in one mutual fund in a complex or family of mutual funds for shares in another mutual fund in the complex or family without having to pay any additional sales charges of any type. Essentially, the exchange is made at the NAV of the shares being exchanged and the NAV of the shares being received in the exchange, in compliance with Section 11 of the 1940 Act and Rules 11a-1 through 11a-3 adopted thereunder. This ability to exchange shares of one fund for another, permits investors a great deal of flexibility to diversify their holdings among multiple funds and to move their investments rapidly (once on any given business day, except for interval funds which are more limited, and subject to trading limitations imposed by the fund complex or family) from investment in one asset class, geographic region, market, mix or company size, etc. to one or more other asset class, geographic region, market, mix or company size, etc. In certain exemplary embodiments of the present invention, the methods/systems provide for such exchange offers and exchanges of New Plan Shares by permitting exchanges between shares of the class of shares purchased (the “New Plan Class”) in one mutual fund for shares of the New Plan Class of shares of other mutual funds in the same mutual fund complex or family, as follows: (1) if there is already a class of shares of the mutual fund that has a commission (e.g., FESC) that may be used as the New Plan Class (which is the case for the vast majority of Mutual Funds, if not all Mutual Funds), or if either (a) the mutual fund has no class of shares of the mutual fund that has a commission that may be used as the New Plan Class or, (b) the mutual fund already has a class of shares of the mutual fund that has a commission that may be used as the New Plan Class, but, at the option of the mutual fund, the mutual fund will determine to adopt a new class of shares of the mutual fund specifically as and for the New Plan Class, the mutual fund will use the class of shares of the mutual fund that already has a commission as its New Plan Class, or the class of shares that is the newly adopted New Plan Class, as the class of shares that will be the New Plan Shares for each mutual fund in the fund complex or family—and in any of the foregoing cases where there is a New Plan Class, the New Plan Class of shares of each mutual fund will have the feature that New Plan Shares of one mutual fund may be exchanged only for New Plan Shares of the same New Plan Class of shares of any other mutual fund in the fund complex or family and that upon any exchange of New Plan Shares in one mutual fund in the fund complex or family, the New Plan Shares received in exchange will have the same features, rights, privileges and obligations as the New Plan Shares given in the exchange—and in adopting a new New Plan Class, the mutual fund complex would have to comply with Rule 22d-1, among other SEC adopted rules, in accord with current practice in the Industry for the various classes of shares adopted by mutual fund complexes or families; (2) if the Mutual Fund has no class of shares of the mutual fund that has a commission (e.g., FESC) that may be used as the New Plan Class, it is unlikely that the mutual fund will not determine to adopt a new class of shares of the mutual fund specifically as and for the New Plan Class—and this is unlikely because according to certain embodiments of the present invention another option to investors to make it easier and potentially more lucrative to invest in the mutual fund is to provide potential investors as many optional avenues for investment in the mutual fund as possible, if the cost is not prohibitive or unprofitable, in order to increase the asset size of the mutual fund—where greater asset size provides opportunities for, among other advantages, economies of scale with respect to expenses, increased investment options, opportunities to attract more highly skilled personnel, heightened publicity and recognition efficiencies in investing the capital available to the mutual fund, and more effective marketing; (3) under exemplary aspects of the present invention, the rights of the lender to receive principal and interest payments from the New Plan Shares shareholder or the insurer, as the case may be, and the insurer's rights and obligations to receive premium payments and make principal and interest payments, as applicable, will carry over from the New Plan Shares given in the exchange to the New Plan Shares received in the exchange and such rights and obligations will attach to the New Plan Shares received in the exchange—and the shareholder may be obligated to make the same amount of payments with respect to the New Plan Shares received in the exchange on the anniversary dates or upon redemption, repurchase or sale, as payments made with respect to the New Plan Shares given up in the exchange—and as discussed above, in the exchange of New Plan Shares between mutual funds in the fund complex or family it will be possible to have arrangements to maintain the secured interest of the lender in the New Plan Shares, to keep records of the ownership of and secured interest in the New Plan Shares and to record changes in ownership of and secured interest in the New Plan Shares; and (4) money market funds (“MMkt Funds”) are a type of mutual fund that introduces a bit of a wrinkle with respect to exchange offers—and the shares offered by MMkt Funds are typically offered without any sales charge and are designed to provide a less risky temporary investment category used for purposes of the investor's cash management and transitions in making more long-term investments, allowing frequent movement of funds into and out of the MMkt Fund—and mutual fund complexes or families typically handle exchanges into and out of MMkt Funds by either (a) creating classes of shares in the MMkt Fund that correspond to the classes of shares in the mutual fund complex with respect to features of 12b-1 fees or CDSCs so that these features carry over from shares exchanged to shares received in exchange, or (b) not permitting exchanges into and out of MMkt Funds without the payment of CDSCs upon exchange from other mutual funds into MMkt Funds and imposition of a CDSC on shares received in exchange for shares of a MMkt Fund—and in another potential embodiment of the present invention, New Plan Shares could offer a method to handle this unique problem of MMkt Fund shares, by having a feature that would permit the repayment of principal to be delayed for the period of time (not to exceed some limit in time, for example, one year) that the amount invested in New Plan Shares are exchanged into and held as MMkt Fund New Plan Shares, with only the continued payment of interest (and possibly payment of premiums (although insurance and premiums may not be necessary or may be significantly reduced during this period of time as MMkt Fund New Plan Shares have a very low risk, that approaches zero risk, of experiencing losses))—and this arrangement could represent a distinct advantage over current 12b-1 fees and a welcome remedy to this unique problem of MMkt Fund shares.

In certain exemplary embodiments of the present invention, an investor can elect at any time to prepay the remaining principal with any interest then due and payable to the lender and insurer at that time, either from redemption, repurchase or sale of New Plan Shares or from other sources of funds the investor has including, but not limited to credit or charge cards. As described above, in case the investor prepays during a repayment period rather than at the end of the repayment period, the insurer will reimburse the investor with the portion of the premium that had been paid for insurance coverage for the then current repayment period, as a pro rata return for the unused coverage for the remaining repayment period after the redemption, repurchase or sale that continues until the end of the current payment period. Thereafter no more payments will be due and payable by the investor to the lender or insurer with respect to the New Plan Shares.

In certain exemplary embodiments of the present invention, for mutual fund shares, the mutual fund may provide for the automatic conversion after a period of years of a class of shares having greater 12b-1 fees to a class have lesser 12b-1 fees or no 12b-1 fees. This conversion feature is designed to reimburse the distributor or other broker for up-front sales commissions paid to brokers at the time of sale by paying the distributor or broker 12b-1 fees over a fixed period of time prior to the conversion. In certain exemplary embodiments of the present invention, it may be that no automatic conversion of the New Plan Shares purchased from the class of shares purchased to another class of shares is necessary at any point in time, since there are no ongoing 12b-1 fees or CDSCs that are being paid by the New Plan Shares purchased that would need to be cut off or reduced at some point by conversion of the New Plan Shares from the purchased class to another class having lesser or no 12b-1 fees or CDSCs. In certain exemplary embodiments of the present invention (see e.g., FIGS. 2 and 3), as described above, no ongoing 12b-1 fees or CDSCs are being paid by the New Plan Shares purchased because the sales charge or commission is paid at time of purchase of New Plan Shares and is not an ongoing asset based sales charge or CDSC as a feature of the New Plan Shares.

In certain exemplary embodiments of the present invention, the insurer (and to the extent that the interest rate charged is variable, the lender) may take hedging positions based on the portfolio securities held by the mutual fund or private investment fund, whose New Plan Shares are purchased by the investor, or based directly on the shares of an individual company or other issuer, as New Plan Shares which the investor purchased, in order to reduce the costs to the insurer, should it be required to pay the principal or interest in a given year (and to protect the lender for reductions in variable interest paid during periods of low interest rates), as further described above. In a specific exemplary variation, the insurer's risks are limited as described above because it is obligated to pay only the then remaining unpaid principal of the commission (e.g., FESC) or other sales commission and the interest on the then remaining unpaid principal of the commission or other sales commission, not the full amount of the investment in the New Plan Shares, in the event there is not enough gain or there is a loss on such New Plan Shares in the then current year. As mentioned above, insurance and premiums may not be necessary or may be significantly reduced during the period of time New Plan Shares are exchanged into MMKt Fund shares, as MMkt Fund New Plan Shares have a very low risk, that approaches zero risk, of experiencing losses, but also are unlikely to have much gains.

In certain exemplary embodiments of the present invention, only the investor that buys the New Plan Shares that are mutual fund shares will pay for the distribution of such shares, avoiding the problem with 12b-1 fees that current investors in the mutual fund pay the 12b-1 fees (in effect, sales charges) supporting distribution of mutual fund shares to other new purchasers. In effect, this means that currently the investment return for all the investors in the mutual fund is reduced in each year by the 12b-1 fees being paid at an annual percentage rate of the NAV of the mutual fund (which may have increased substantially in NAV since an investor purchased shares). All of the investors in the mutual fund experience this reduced investment return, even though many investors in the mutual fund may not have purchased shares in the mutual fund for many years and yet will continue to pay for the distribution of shares of the mutual fund to other new purchasers.

In certain exemplary embodiments of the present invention, an investor pays, for mutual fund New Plan Shares, only the commission (e.g., FESC) principal amount calculated as a percentage of the initial purchase price of the New Plan Shares, plus interest and premiums. This means that the investor does not have to pay, as currently, under 12b-1, more and more sales charges if the New Plan Shares appreciate in value, which generates a higher absolute amount of sales charges because the 12b-1 fees percentage is applied to the entire NAV of the New Plan Shares, including both the original purchase amount of NAV and any appreciation in such NAV.

In certain exemplary embodiments of the present invention, a flexible arrangement is provided, in that the investor has the option to prepay the amount owed at any time, such as in the case where there is a very large appreciation in the New Plan Shares in a given year (a situation where, for mutual fund shares under 12b-1, the investor would pay a much higher sales charge as a percentage of such appreciation in the given year, but still owe 12b-1 fees for the same number of mutual fund shares in following years, regardless of such increase in sales charges paid in absolute terms in the given year). Also, in certain exemplary embodiments of the present invention, the arrangement may be structured for various periods of repayment, for as short a period as six months or one year or as long a period as ten years or more. The inventive methods/systems compare very favorably, for example, to Class C mutual fund shares, which currently typically have 12b-1 fees that are paid year after year indefinitely, ending only when the investor has the mutual fund redeem or repurchase the Class C shares. The investor in Class C shares must know in what year, after purchase of the shares, the investor will have paid an aggregate amount of 12b-1 fees (including by tracing variations with increases or decreases in the NAV of the Class C shares) that exceeds the amount of a commission (e.g., FESC) or CDSC the investor would have paid if the investor had invested in a class of shares of the mutual fund that has a commission (e.g., FESC) or CDSC (with the cessation or substantial reduction of the 12b-1 fees by automatic conversion at some point after the deferred period) instead of in the Class C shares (which has no such cessation or reduction). Once such 12b-1 fees for the Class C shares exceed what the investor would have paid if the investor had invested in the other class of shares, the investor is faced with the dilemma, if the investor wishes to remain invested in the mutual fund, of either (1) having the Class C shares redeemed or repurchased by the mutual fund and reinvesting the proceeds in other shares, perhaps paying a commission (e.g., FESC), CDSC or new 12b-1 fees for the new investment, or (2) keeping the Class C shares and continuing to pay the 12b-1 fees for the following years.

In certain exemplary embodiments of the present invention, the methods/systems may ensure that the lender has reliable, creditworthy sources for the repayment of the principal and interest on the amount of the commission (e.g., FESC) that is financed, from three sources: (1) the investor; (2) the mutual fund shares or other shares held as collateral; and (3) the insurer.

In certain exemplary embodiments of the present invention, for mutual fund shares, the principal underwriter or distributor of the mutual fund's shares does not have to finance the sales commissions or charges on sale of New Plan Shares paid to sales agents as compensation for their selling the shares, as is currently done under 12b-1 with Class B and Class C shares, or make expensive, burdensome and time-consuming arrangements to have a financing company provide the financing for such sales commission or charges payments as compensation to the sales agents.

In certain exemplary embodiments of the present invention, in contrast to conventional 12b-1 arrangements, the inventive methods/systems may more closely measure the compensation of the sales agent against the services provided by the sales agent, instead of allowing the sales agent to share in the capital gains (and losses) of the investor. In receiving 12b-1 fees compensation from investors, broker-dealer members share in the profits and losses effecting the share accounts of mutual fund investors and the mutual fund, itself, in that the 12b-1 fees increase or decrease based on the daily increasing or decreasing NAV of the mutual fund under circumstances where the broker-dealer has made no financial contribution to such share accounts or its mutual fund customer. The inventive methods/systems would also foster growth in the mutual fund through adding new shareholders, more assets for a greater NAV and economies of scale, all of which will result in higher investment returns for the mutual fund. This growth, lower costs and higher investment returns is engendered by not reducing the NAV of the Mutual Fund through imposition of 12b-1 fees, which in effect amount to higher costs of distribution for the Mutual Fund.

Through certain exemplary embodiments of the present invention, shareholders would no longer pay an asset-based sales charge as an expense in addition to their other asset-based expenses. More specifically, a problem of sales agents receiving higher sales charges through 12b-1 fees generated over time in combination with a CDSC (versus another mutual fund with a higher commission, but with a less sales charges in the aggregate over time) may be mitigated by making the increased sales charge amounts transparent to the investor, allowing the investor to compare one sales charge arrangement against another, so that any higher commission (e.g., FESC) would be charged based on competition among mutual funds.

More specifically, for the investor, the absolute amount of the maximum commission (e.g., FESC) to be charged would be disclosed to the investor at time of sale in accordance with a cardinal goal of the securities laws to provide complete and accurate disclosure to investors prior to investment. The Investor would not need to wade through complex fund remuneration programs to determine the potential sales charges associated with a given fund.

From the perspective of sales agents, according to the inventive methods/systems, the volume of sales will likely be increased, as investors benefit from increased investment returns, so that the aggregate profits received by sales agents may not be significantly impacted or may actually increase as compared to fees generated from 12b-1 plans. Also, in certain exemplary embodiments of the present invention, the broker-dealers may be paid immediately upon sale of mutual fund shares, rather than having to wait for the accrual of 12b-1 fees year to year or the payment of a deferred sales charge after a period of years.

From the perspective of investment advisers, according to the inventive methods/systems, mutual fund advisers may benefit from increased investment management fees, which are generated when the NAV of the mutual fund increases (due to increased purchases of shares engendered by higher investment returns and lower asset based expenses, such as 12b-1 fees).

As described herein, the inventive methods and systems are solutions to the 12b-1 issues for all classes of mutual fund shares that have 12b-1 fees, including especially Class B shares and Class C shares, which normally have substantially greater 12b-1 fees.

According to certain exemplary embodiments of the present invention, methods and systems for a lender to advance to an investor (shareholder), who purchases shares, sales commissions the investor pays to broker-dealers in connection with the investor's purchase of securities of or shares of interests in a company as disclosed in the specification of this application, are provided.

According to certain exemplary embodiments of the present invention, methods and systems for a lender to advance to an investor, who purchases shares, sales commissions the investor pays to broker-dealers in connection with the investor's purchase of shares of interests in a company registered under the investment company Act of 1940 as disclosed in the specification of this application for use to replace traditional Rule 12b-1 fees or deferred sales charges, contingent or otherwise, are provided.

According to certain exemplary embodiments of the present invention, methods and systems for an investor to make installment payments, using the appreciation in value of securities of or shares of interests in a company, which the investor has purchased, or other resources, to repay a lender which has advanced to the investor, who purchases such securities or shares, sales commissions the investor pays to broker-dealers in connection with the investor's purchase of such securities or shares as disclosed in the specification of this application, are provided.

According to certain exemplary embodiments of the present invention, methods and systems for investor to make installment payments, using the appreciation in value of shares of interests in a company registered under the Investment Company Act of 1940, which the investor has purchased, or other resources, to repay a lender which has advanced to the investor, who purchases such shares of interests, sales commissions the investor pays to broker-dealers in connection with the investor's purchase of such shares of interests as disclosed in the specification of this application for use to replace traditional Rule 12b-1 fees or deferred sales charges, contingent or otherwise, are provided.

According to certain exemplary embodiments of the present invention, computer-based methods and systems for a lender to advance to an investor, who purchases shares, sales commissions the investor pays to broker-dealers in connection with the investor's purchase of securities of or shares of interests in a company as disclosed in the specification of this application, are provided.

According to certain exemplary embodiments of the present invention, computer-based methods and systems for a lender to advance to an investor, who purchases shares, sales commissions the investor pays to broker-dealers in connection with the investor's purchase of shares of interests in a company registered under the Investment Company Act of 1940 as disclosed in the specification of this application for use to replace traditional Rule 12b-1 fees or deferred sales charges, contingent or otherwise, are provided.

According to certain exemplary embodiments of the present invention, computerized methods and systems for both stationary and mobile computer or smart phone communication or information technology devices by which a lender may advance to an investor, who purchases shares, sales commissions the investor pays to broker-dealers in connection with the investor's purchase of securities of or shares of interests in a company as disclosed in the specification of this application, are provided.

According to certain exemplary embodiments of the present invention, computerized methods and systems for both stationary and mobile computer or smart phone communication or information technology devices by which a lender may advance to an investor, who purchases shares, sales commissions the investor pays to broker-dealers in connection with the investor's purchase of shares of interests in a company registered under the Investment Company Act of 1940 as disclosed in the specification of this application for use to replace traditional Rule 12b-1 fees or deferred sales charges, contingent or otherwise, are provided.

According to certain exemplary embodiments of the present invention, methods and systems for an insurance company to provide insurance coverage for (a) advances paid by a lender to an investor, and (b) interest thereon due and payable to the lender by an investor, who purchases shares, with respect to sales commissions the investor pays to broker-dealers in connection with the investor's purchase of shares of interests in a company as disclosed in the specification of this application, are provided.

According to certain exemplary embodiments of the present invention, methods and systems for an insurance company to provide insurance coverage for (a) advances paid by a lender to an investor, and (b) interest thereon due and payable to the lender by an investor, who purchases shares, with respect to sales commissions the investor pays to broker-dealers in connection with the investor's purchase of shares of interests in a company registered under the Investment Company Act of 1940 as disclosed in the specification of this application for use to replace traditional Rule 12b-1 fees or deferred sales charges, contingent or otherwise, are provided.

Methods and systems for creating and implementing a new means for a lender to advance to an investor, who purchases shares or securities, sales commissions the investor pays to broker-dealers in connection with the investor's purchase of the shares of interests in, or securities of, a company are disclosed. In one preferred embodiment, the inventive methods and systems have direct application to provide for an investor to make installment payments, using the appreciation in value of securities of or shares of interests in a company, which the investor has purchased, or other resources, to repay the lender, which has advanced to the investor, who purchases such securities or shares, sales commissions the investor pays to broker-dealers in connection with the investor's purchase of such securities or shares. In other preferred embodiments, the inventive methods and systems have direct application to replace traditional Rule 12b-1 fees charged for many classes of Mutual Fund shares, including Class B shares and Class C shares. In other preferred embodiments, the inventive methods and systems have application to replace other fees, similar to Rule 12b-1 fees where an advance of sales commissions is involved. In other preferred embodiments, the inventive methods and systems have application to allow the lender to retain a security interest in the shares or securities purchased to protect the amount of the commissions advanced by the lender and any interest accrued on the advance. In other preferred embodiments, the inventive methods and systems have application to allow an insurance company to provide insurance coverage with respect to the amount of the commissions advanced by the lender and any interest accrued on the advance. In still other preferred embodiments, the inventive methods and systems have application to allow the lender who has advanced the amount of the commissions to make arrangements to lend for compensation the shares or securities purchased by the investor to broker-dealers who engage in such securities lending arrangements. In still other preferred embodiments, the inventive methods and systems have application to allow the lender who has advanced the amount of the commissions to make arrangements to lend funds to the investor using as collateral the shares or securities purchased by the investor in which the lender retains a security interest.

While certain exemplary embodiments have been disclosed and described with respect to the inventive methods and systems, other configurations are contemplated (with or without insurance coverage/features), for example, related to a lender advancing funds (to cover sales commissions) to an investor who purchases shares, where the sales commissions are to be paid to broker-dealers in connection with the investor's purchase of shares of interests in an investment company.

In certain alternative embodiments for implementing the inventive methods and systems, this new financing product employs three agreements: (1) a financing and insurance agreement by and among the lender, the insurer (if desired) and the mutual fund/investment company (the “Lender Agreement”); (2) a principal underwriter agreement (distribution agreement) agreement by and between the mutual fund/investment company and the broker (the “Broker Agreement”); and (3) a financing agreement that is part of the account application by and between the mutual fund/investment company and the investor/shareholder (the “Investor Agreement”), as follows: (1) under the Lender Agreement—(a) the mutual fund (investment company) has a revolving line of credit from the lender from which the mutual fund may withdraw funds for the purposes of funding sales of shares of the mutual fund of a class of shares of the mutual fund, which are designated and classified by the mutual fund for this channel of distribution (“Class One”), and upon which the mutual fund pays interest to the lender (“Lender Interest”)—(b) at the end of each business day or week or other period, under the Broker Agreement the broker (principal underwriter) provides a report (“Sales Report”) to the mutual fund reporting the aggregate amount of sales commissions to be paid by the broker to its selling brokers and dealers (in the broker-dealer's network), for sales on such business day or during such business week, as the case may be, of Class One shares of the Mutual Fund—(c) based on the Sales Report, at the end of each business day or week, or other period as the case may be, the mutual fund pays the broker-dealer the amount of the aggregate sales commission for the applicable period, withdrawing this amount from the mutual fund's line of credit with the lender—(d) as the mutual fund recovers principal and interest payments from the investors under the Investor Agreements, the mutual fund repays amounts withdrawn from the revolving line of credit under the Lender Agreement—and (e) the interest payments due and payable by the investors exceeds the Lender Interest so that the mutual fund retains and accrues for itself interest payments from the investor to offset its expenses in paying the transfer agent, accounting transactions, etc. and recovering principal and interest from the investors and accounting for these transactions; (2) under the Broker Agreement, among other matters—the broker provides, to the mutual fund, Sales Reports of the aggregate sales commissions the broker is obligated to pay the selling brokers and dealers in the broker's dealer network for the relevant period; (3) under the Investor Agreement—(a) the investor agrees to repay to the mutual fund the amount of the sales commission and interest due on the sales commission in installment payments for designated time periods during the time the investor owns the Class One shares, or in the event that the investor sells its Class One shares without investing the proceeds in Class One shares of another series fund of the mutual fund, the investor will repay the remaining principal and interest due at the time of the sales of the Class One shares, using either the investor's own resources or, if the Investor does not do so, using the proceeds of the sale of the investor's Class One shares, which the mutual fund may withhold from the proceeds of the sale of the Class One shares—(b) the investor agrees that if the investor does not pay the principal and interest installment payments by the due date at the end of the then current designated time periods during the time the investor owns the Class One shares, as notified by the mutual fund in advance of the due date, the mutual fund may automatically sell Class One shares held by the investor in an amount that will cover the amount of the then due principal and interest installment payment—(c) the interest payments due and payable by the investors exceeds the Lender Interest so that the mutual fund retains and accrues for itself a portion of the interest payments paid by the investor to offset the mutual fund's expenses in paying the broker and recovering principal and interest from the investors and accounting for these transactions—and (d) the investor will be able to pay principal, interest and premium charges, if any, from (i) the investor's own resources, or (ii) the return the investor earns on the Class One shares the investor bought, if the Class One shares increase in value, or have the payments made by the insurance company (as set forth in the appropriate insurance agreement) if the Class One shares do not increase in value, during each relevant period; (4) for lenders/banks—the benefits to the lenders includes—(a) the lender earning interest on the amount of sales commission advanced over the life of the loan to the investment company to cover the sales commissions—(b) the lender is covered against loss by a security interest in the securities bought and by the insurance covering any losses in the value of securities—(c) a lender affiliated with a broker-dealer can potentially lend the securities bought by the investor in which the bank has a security interest during the period of the advance to the investor which reduces the interest that must be charged—and (d) the lender may avoid the costs, delays and difficulties in negotiating complex financing agreements with funds and distributors and all the risks of administration and regulatory change; (5) additional investor benefits include—(a) the full amount of the investor's investment begins earning a return immediately with no reduction to pay the sales commission, enhancing the return the investor will receive over the life of the investment—(b) the amount of sales charges the investor will pay will be fixed, and not subject to increase based on the appreciation in value of the securities (as in the case of 12b-1 fees)—(c) the investor will receive up-front disclosure of the full amount of sales charges the investor will pay, including interest and premium payments—and (d) the investor will be able to pay principal, interest and premium charges from (i) its own resources or (ii) the return the investor earns on the securities, if they increase in value, or have the payments made by the insurance company (if any) if the securities do not increase in value during the annual period; (6) for lenders to offer broker-dealers benefits including—(a) a broker-dealer can broker securities without having investors face large FESCs or vague sales charges that have the potential to balloon over time and reduce investor return making investors more likely to invest and more satisfied with returns—(b) contrast the arrangement where the broker-dealer fronts the funds to pay FESCs in return for 12b-1 fee receivables over time, so the broker-dealer will not have to either take large reductions in its net capital position to cover sales charge financing over time a net capital position it must maintain under securities regulations, or find a source of financing to cover sales charge financing over time and pay for expensive negotiation and documentation of such financing; and (7) for lenders to offer insurance companies benefits including (a) the insurance company has a new insurance product—(b) the new insurance product has a low risk—covering losses designated in insurance contracts (which may vary considerably within the scope of the present invention), for example, for the amount due for principal and interest in a given year, if the return on the securities bought is not enough to cover the annual principal and interest due for that year on the amount advanced for the sales charges.

Although the present invention has primarily been described with respect to specific types of investment companies, the present invention is not limited thereto. More specifically, the inventive systems and methods described herein are applicable to various other types of companies (e.g., other types of investment companies, publicly held companies, privately held companies, etc.). Further, other arrangements may be covered within scope of the present invention, including, for example, platforms involving multiple mutual funds, and revenue sharing arrangements whereby investment advisers or distributers of mutual funds may share their revenues to pay sales commissions to sales agents in connection with the purchase of shares by certain shareholders of the mutual funds.

Although illustrated and described above with reference to certain specific embodiments, the present invention is nevertheless not intended to be limited to the details shown. Rather, various modifications may be made in the details within the scope and range of equivalents of the claims and without departing from the spirit of the invention.

What is claimed:

1. A method of purchasing shares of an investment company, the method comprising the steps of:
(a) purchasing shares of an investment company to become a shareholder in the investment company, the investment company being selected from the group consisting of (i) a registered open end investment company, and (ii) an interval fund;
(b) financing, through a loan in the name of at least one of the shareholder and the investment company, a commission on the shares such that proceeds from the loan may be paid to at least one party due to receive the commission under a purchase agreement of the shares.

2. The method of claim 1 wherein the loan is financed in step (b) in the name of the shareholder.

3. The method of claim 1 wherein the loan is financed in step (b) in the name of the investment company.

4. The method of claim 3 wherein the loan includes funding for additional commissions on additional shares of at least one investment company.

5. The method of claim 1 wherein step (a) is performed using a first computer for issuing an order for the shares of the investment company for the shareholder, and a second computer for receiving the order for the shares of the investment company.

6. The method of claim 5 wherein the first computer is accessed in step (a) by at least one of (i) the shareholder and (ii) a selling broker with rights to order shares of the investment company.

7. The method of claim 1 further comprising the step of (c) the shareholder acquiring an insurance policy to insure at least a portion of the repayment of the loan.

8. The method of claim 7 wherein the insurance company pays a portion of the loan if the shares purchased in step (a) do not reach a predetermined level of appreciation during a predetermined time period.

9. The method of claim 1 further comprising the step of (c) the investment company acquiring an insurance policy to insure at least a portion of the repayment of the loan.

10. The method of claim 1 wherein the commission is a front-end sales charge related to the shares purchased in step (a).

11. A system for purchasing shares of an investment company, the system comprising:
(a) an investment company, the investment company being selected from the group consisting of (i) a registered open end investment company, and (ii) an interval fund;
(b) shares of the investment company available for purchase by a shareholder;
(c) a financing channel configured to provide a loan in the name of at least one of the shareholder and the investment company, the loan being provided to cover a commission on the shares such that proceeds from the loan may be paid to at least one party due to receive the commission under a purchase agreement of the shares.

12. The system of claim 11 further comprising a first computer for issuing an order for the shares of the investment company for the shareholder, and a second computer for receiving the order for the shares of the investment company.

13. The system of claim 11 wherein the first computer is accessed by at least one of (i) the shareholder and (ii) a selling broker with rights to order shares of the investment company.

14. The system of claim 11 wherein the loan is provided in the name of the shareholder.

15. The system of claim 11 wherein the commission is a front-end sales charge related to the shares.

16. The system of claim 11 further comprising a software application for ordering the shares by, or on behalf of, the shareholder.

17. The system of claim 11 further comprising a software application for entering into the loan to finance the commission by, or on behalf of, the shareholder.

18. The system of claim 11 further comprising an insurance procurement software application for ordering insurance to insure repayment of at least a portion of the loan by, or on behalf of, the shareholder.

19. The system of claim 11 wherein the loan is financed in the name of the shareholder.

20. The system of claim 11 wherein the loan is financed in the name of the investment company.
